(19) United States
(12) Patent Application Publication
(10) Pub. No.: US 2015/0088853 A1
(43) Pub. Date: Mar. 26, 2015

(54) GEOSPATIAL SEARCH PORTAL, METHODS OF MAKING AND USING THE SAME, AND SYSTEMS INCLUDING THE SAME

(71) Applicant: California State University Fresno, Fresno, CA (US)

(72) Inventor: Peter McDonald, Fresno, CA (US)

(73) Assignee: California State University Fresno, Fresno, CA (US)

(21) Appl. No.: 14/034,355

(22) Filed: Sep. 23, 2013

(51) Int. Cl. G06F 17/30

(52) U.S. Cl. CPC G06F 17/3002; G06F 17/30038; G06F 17/30061; G06F 17/30126
USPC 707/711

(57) ABSTRACT

A geospatial search portal, systems including the same, and methods of making and using the geospatial search portal are disclosed. The geospatial search portal generally includes an electronic information harvester, a tagger, metadata analysis logic, an electronic map having a plurality of electronic locations thereon, and a processor. The electronic information harvester seeks and retrieves relevant scholarly, technical, encyclopedic, factual and/or archival information. The tagger associates a plurality of georeferences and a plurality of metadata to each item of information. The metadata analysis logic analyzes the metadata and organizes the metadata into index terms and/or map symbols, and may comprise an indexer and a depictor. The processor is configured to display at least some of the associated information on the electronic map and/or in a textbox when the electronic location(s) on the electronic map, the georeference(s), and/or the metadata is/are electronically selected.

### FIELD OF THE INVENTION

The present invention generally relates to the field of information collection, linking, storage, and searching. More specifically, embodiments of the present invention pertain to a geospatial search portal, methods for making and using the same, and systems including the same.

### BACKGROUND OF THE INVENTION

Searches using a search engine such as Google® provide the user with little or no input into, or ability to change or influence, the mechanism(s) of the search algorithm. Furthermore, it is difficult or impossible for the average Internet user to discern the criteria by which hits are retrieved in response to a search.

The Internet is often used for technical research and/or learning. However, there are few (if any) readily available and/or unrestricted search tools that focus or limit the results to factual, scholarly or authoritative information. There are none known to the inventor that associate such information with geographic locations.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

Embodiments of the present invention relate to a geospatial search portal, comprising an electronic information harvester, a tagger, metadata analysis logic, an electronic map having a plurality of electronic locations thereon, and a processor. The electronic information harvester seeks and retrieves relevant scholarly, technical, encyclopedic, factual and/or archival information. The tagger associates a plurality of georeferences and a plurality of metadata to each of the scholarly, technical, encyclopedic, factual and/or archival information. The metadata analysis logic analyzes the metadata and organizes the metadata into index terms and/or map symbols. The geospatial search portal further includes a system that relates or associates each of the georeferences to one or more of the electronic locations identified in the index terms, the metadata, and/or the scholarly, technical, encyclopedic, factual, and/or archival information. The processor is configured to display at least some of the associated scholarly, technical, encyclopedic, factual and/or archival information on the electronic map and/or in a textbox when the electronic location(s) on the electronic map, the georeference(s), and/or the metadata is/are electronically selected. The present search portal also includes a system that relates or associates each of the plurality of georeferences to each of the plurality of electronic locations. The scholarly, technical, encyclopedic, factual and/or archival information generally relates to one or more physical locations corresponding to at least one of the georeferences.

In some embodiments of the present search portal, the electronic map has a plurality of scales, each of the scales representing a different predetermined distance per unit length on the electronic map. In one example, the electronic map is divided into an array of tiles, the tiles having dimensions fixed to one of the plurality of scales, where each of the electronic locations corresponds to one or more of the tiles. Alternatively, the electronic map can be divided into an array of regions or sets of coordinates, and each of the electronic locations corresponds to one or more of the regions or sets of coordinates.

The metadata analysis logic may include an indexer and a depictor. The indexer analyzes each of the metadata and organizes the metadata into index terms, and the depictor analyzes each of the metadata and organizes the metadata into map symbols.

In other embodiments, the search portal further includes a user interface. The user interface may be adapted to display the map symbols in the map and one or more optional function areas or windows outside the map. Each of the map objects and the index terms may be adapted to perform a predetermined function on the map and/or the other of the map objects and the index terms. Alternatively or additionally, the function area(s) or window(s) may be adapted to display one or one or ones of said map symbols, each said map symbol being adapted to perform a predetermined function on the index terms. The search portal may further comprise one or more menus adapted to offer a plurality of predetermined functions for changing, displaying or configuring the electronic map, the map symbols, and/or the index terms.

Further embodiments of the present invention include a system, comprising the present geospatial search portal, a server or storage device configured to store the georeferences, the metadata, and links or electronic associations between the georeferences and the corresponding electronic location(s) on the electronic map, and an electronic display device. The electronic display device displays the electronic map, identified and predetermined locations on the electronic map (if any), relevant information identified in a search (if any), and optionally, a search window to be displayed on the user interface. The search window may be adapted to receive search terms for identifying the relevant information on the electronic map. The present system may further comprise a computer configured to manage read, write, address assignment and/or identification operations of the one or more information storage units and one or more information storage units configured to store the georeferences, the metadata, and the links or electronic associations, and/or a computer configured to manage read, write and address assignment operations and/or identification operations of the information storage unit(s).

Another aspect of the present invention relates to a method of designing, creating, producing or making a search portal, comprising importing or creating an electronic map having a plurality of electronic locations thereon; identifying and/or retrieving scholarly, technical, encyclopedic, factual and/or archival information; tagging each of the scholarly, technical, encyclopedic, factual, and/or archival information with georeferences and metadata; linking the georeferences with or to the electronic locations on the electronic map; analyzing and organizing each of the metadata into index terms and map symbols; and configuring a processor to display at least some of the scholarly, technical, encyclopedic, factual and/or archival information, when a corresponding one or ones of the electronic locations, georeferences, metadata, index terms, and/or map symbols is/are electronically selected.

In some embodiments of this method, the electronic map is divided into an array of tiles. Additionally or alternatively, each of the plurality of electronic locations corresponds to a predetermined region or set of coordinates on the electronic map. Each of the predetermined region(s) or set(s) of coordinates may correspond to a predetermined tile in the array of the tiles.

In a further aspect of this method, configuring the processor to display at least some of the scholarly, technical, encyclopedic, factual and/or archival information comprises creating (or, alternatively, importing) a user interface configured to display the electronic map, identified and predetermined locations on the electronic map, and relevant information identified in a search. The user interface may further comprise a search box (or window) adapted to receive search terms for identifying the relevant information on the electronic map, and at least one of (i) a function area adapted to display one or more index terms, each of the index term(s) being adapted to perform a predetermined function on the electronic map, the map symbols, the index terms, and/or the relevant information, (ii) a function window adapted to display one or more of the map symbols, each of the map symbols being adapted to perform a predetermined function on one or more index terms, the electronic map and/or the relevant information; and (iii) a menu adapted to offer a plurality of predetermined functions for changing or configuring the electronic map and/or the index terms.

According to a further aspect of the present invention, a method of obtaining information relating to an actual geographic location generally comprises searching for information using a geospatial search portal, viewing retrieved information, and optionally exporting or printing at least some of the retrieved information. The geospatial search portal generally comprises an electronic map having one or more electronic locations thereon and metadata analysis logic. The information generally includes scholarly, technical, encyclopedic, factual and/or archival information electronically associated with and/or linked to one or more of the electronic location(s). The scholarly, technical, encyclopedic, factual and/or archival information generally relates to an actual location represented by a corresponding electronic location on the electronic map. The metadata analysis logic analyzes the metadata and organizes the metadata into index terms and/or map symbols The search portal further comprises a user interface configured to display the electronic map, a predetermined and/or identified electronic location on the electronic map, and at least some of the scholarly, technical, encyclopedic, factual and/or archival information relating to the actual location when the identified/corresponding electronic location on the electronic map, one or more map symbols, and/or one or more georeferences is/are electronically selected. The term “exporting” (and grammatical equivalents thereof) covers information management operations such as transferring, copying, moving and/or storing.

The method of obtaining information may further comprise causing a processor to (i) identify a particular electronic location on the electronic map, and (ii) refine or reconfigure the electronic map and/or the scholarly, technical, encyclopedic, factual and/or archival information relating to the actual location. Alternatively or additionally, the method of obtaining information may further comprising filtering the information or selecting a predetermined type of the information using further search criteria, a function command, and/or a selectable item from a pull-down menu.

The present invention may also relate to a non-transitory computer-readable medium containing a set of instructions stored thereon which, when executed by a signal processing device configured to execute computer-readable instructions, is configured to perform the present method of obtaining information. These and other aspects of the present invention will become readily apparent from the detailed description of various embodiments below.

### BRIEF DESCRIPTION OF THE DRAWINGS

FIG. 1 shows components for an exemplary geospatial search portal in accordance with the present invention.

FIG. 2 shows an exemplary user interface suitable for an exemplary geospatial search portal in accordance with the present invention.

FIG. 3 is a diagram of an exemplary layout including an exemplary set of coordinates suitable for the present search portal.

FIG. 4 shows the exemplary user interface of FIG. 1, zooming in on a selected region within the map shown in FIG. 2.

FIG. 5A shows the exemplary user interface of FIGS. 2 and 4, zooming in on a selected region within the map shown in FIG. 4.

FIGS. 5B-C show exemplary menus for filtering or selecting a predetermined type of information to be shown in or on the map of FIG. 5A.

FIG. 6A is a flow chart for an exemplary method of harvesting and processing information for a geospatial search portal in accordance with aspects of the present invention, and FIG. 6B is a diagram of an exemplary system for displaying harvested and processed data and/or information in accordance with aspects of the present invention.

FIGS. 7A-C are flow charts for exemplary methods of using a geospatial search portal to find relevant scholarly, technical, encyclopedic, factual and/or archival information about a particular location in accordance with another aspect of the present invention, including a text-based search method (FIG. 7A), a selection method using a dynamic index window containing updatable index terms, metadata, symbols, etc. (FIG. 7B), and a cursor-based method (FIG. 7C).

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention. Also, various aspects, embodiments and/or examples disclosed herein may be combined with other aspects, embodiments and/or examples, as long as such combinations are not explicitly disclosed herein as being unfavorable, undesirable or disadvantageous.

Unless specifically stated otherwise, or as will be apparent from the following discussions, it is appreciated that throughout the present application, discussions utilizing terms such as “processing,” “operating,” “calculating,” “determining,” or the like, refer to the action and processes of a computer, data processing system, or similar processing device (e.g., an electrical, optical, or quantum computing or processing device or circuit) that manipulates and transforms data represented as physical (e.g., electronic) quantities. The terms refer to actions and processes of the processing devices that manipulate or transform physical quantities within the component(s) of a circuit, system or architecture (e.g., registers, memories, other such information storage, transmission or display devices, etc.) into other data or information similarly represented as physical quantities within other components of the same or a different system or architecture.

Furthermore, in the context of this application, the terms “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use, unless the context of the term's use unambiguously indicates otherwise. Such terms may be used interchangeably, but these terms are also generally given their art-recognized meanings.

A geospatial, encyclopedic search portal has been designed that allows the user to employ an interactive map that actively encourages the user to explore a virtual world of geographically coded information. In one embodiment, the interactive map is a multi-dimensional map. Regardless of age, technical skill level, or demographic, users will be able to search for information that is factual and/or educational in nature (e.g., scholarly, authoritative, encyclopedic, archival or scientific data, photographs, videos, articles, diaries, etc.), rather than consumerist (e.g., business and/or consumer products and/or services). The human brain associates information with a physical place, and the present search portal associates or anchors historical and factual information to a relevant physical location. Instead of reading disembodied facts and figures described in texts, the user can use the search portal to understand how facts and figures interact with and/or are intertwined in the physical location. This approach is expected to facilitate retention of educational information (e.g., as taught to students, learned by businesspeople or governmental authorities, etc.). It should also stimulate exploration (or further exploration) of a physical area, similar to students being taken on a field trip. The present search portal enables limitless virtual field trips to almost anywhere in the world.

The present geospatial search portal differs from a search engine text box search, in whole, because it is spatial/geographic, interactive, customizable and exploratory. The underlying technology may be, for example, GIS-based, and puts the searcher right into a virtual representation of the globe, providing layered access to authoritative multi-disciplinary content that is coded to the topic of the search and associated with its geographic location (e.g. Henry VIII to England or scissor-tailed flycatchers to their migratory routes).

The present search portal provides an interactive, customizable information-seeking experience well beyond the simple harvesting of URL-based websites provided by today's textual search engines (Google, Yahoo, Bing, etc.). Depending on what search term(s) are input, or the research skills of the user, one is immediately able to modify one's information retrieval needs and experience at every step of the exploration. All layers of information are coded to and/or associated with one or more locations (e.g., the search term “Eiffel Tower” shows a map in Paris, the search term “orangutans” shows a map containing at least parts of Indonesia and Malaysia [where orangutans are found in the wild] and/or zoos where orangutans reside, the search term “Henry VIII” shows a scanned map of 16th century England, and so on).

Users are provided multiple ways to search. Some examples include the following:
Users may go virtually anywhere, either on a computer or on a mobile device, and explore the world of information geo-spatially.
Users may select any location on the globe, and drill down through a number of information layers relevant to that particular location.
A subject/keyword search can be performed and executed or implemented on a two-dimensional atlas or map or a three-dimensional globe geo-coded to the search topic.
A format (content-type) search can be performed (for example, to retrieve only videos or photographs, scanned manuscripts or scientific GIS data) that is pertinent to the search topic or location.
Geospatial searches can be performed chronologically (e.g., by year, decade, century or era).
Geospatial searches can be performed by content provider (e.g., specific to a particular federal agency, or a named university or historical society), and may be linked to a database and/or the World Wide Web (e.g., Wikipedia).
Geo-coding of some/all content can allow mobile application design, which with further implementation and development of certain technologies, can enable GPS-based or -located information to be displayed on the user's mobile device as the user travels anywhere, revealing content as the user approaches or passes near, into or through the physical location (e.g., for school bus and other tours, etc.).
   This search system is built to be scalable and to be infinitely expandable.

The invention, in its various aspects, will be explained in greater detail below with regard to exemplary embodiments.

An Exemplary Geospatial Search Portal

In one aspect, the present invention relates to a geospatial search portal, comprising a geospatial search portal, comprising an electronic information harvester that seeks and retrieves relevant scholarly, technical, encyclopedic, factual and/or archival information; a tagger that associates a plurality of georeferences and a plurality of metadata to each of the scholarly, technical, encyclopedic, factual and/or archival information; logic that analyzes each of the metadata and organizes the metadata into index terms and/or map symbols; an electronic map having a plurality of electronic locations thereon; a system that relates or associates each of the georeferences to one or more of the electronic locations identified in the index terms, the metadata, the map symbols, and/or the scholarly, technical, encyclopedic, factual, and/or archival information; and a processor configured to display at least some of the associated scholarly, technical, encyclopedic, factual and/or archival information on the electronic map and/or in a textbox when one or more electronic locations on the electronic map, one or more georeferences, and/or one or more items of metadata is/are electronically selected. In one embodiment, the logic comprises (i) an indexer that analyzes each of the metadata and organizes the metadata into index terms, and (ii) a depictor that analyzes each of the metadata and organizes the metadata into map symbols.

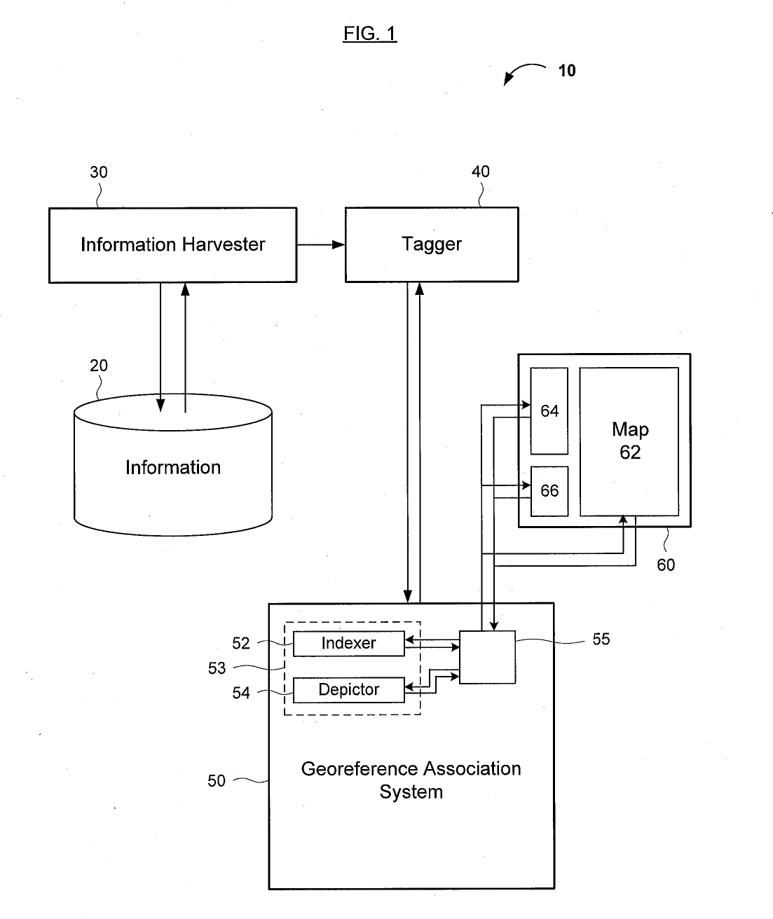

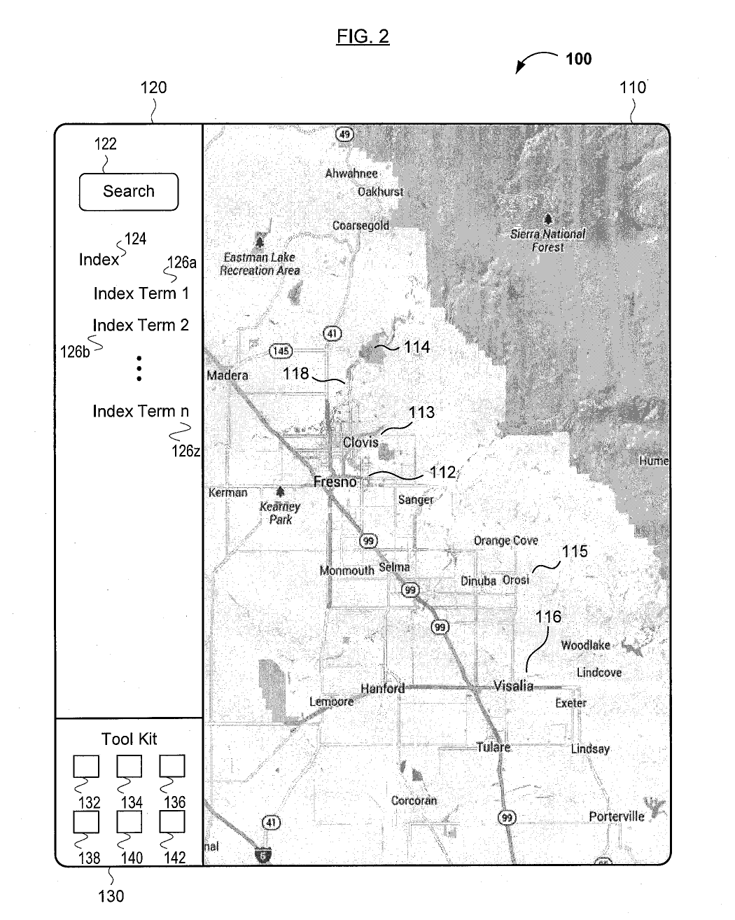

FIG. 1 shows an exemplary system 10 implementing the present geospatial search portal. The exemplary system 10 includes information 20, information harvester 30, tagger 40, georeference association system 50 including metadata analysis logic 53 (comprising an indexer 52 and a depictor 54), a processor 55, and display 60. The display 60 includes a map 62, a search window 64, and an index 66.

Information 20 can be found on the Internet (e.g., the World Wide Web) and/or in one or more databases. Such databases may be or comprise one or more hard disks, arrays or farms of storage disks, a cloud-based information storage system, etc. As mentioned elsewhere herein, individual units of information 20 may take the form of data, photographs, videos, articles, documents, spreadsheets, presentations, diaries, etc. The documents may be, for example, in a portable document format, hypertext markup language, or conventional word processing or plain text format.

The information harvester 30 generally scans the information 20 to obtain scholarly, technical, encyclopedic, factual, and/or archival information from information 20. Thus, in response to search commands or instructions from information harvester 30, information (or information source) 20 may send one or more units of information. The information retrieved by information harvester 30 is generally technical, encyclopedic, educational, factual, scholarly, scientific, authoritative and/or archival information, rather than commercial or advertising-based. As a result, the information that is located during a search may be limited by its source (e.g., its publisher, such as a university or other institution of learning, a research institution, a refereed or other technical journal recognized by those in the art as authoritative or generally reliable, a government bureau, agency or other government organization, etc.).

The tagger 40 identifies and categorizes the information harvested by the information harvester 20. For example, the tagger 40 may identify and categorize certain harvested information as a .gis file, text, a photo, an audio and/or video file, etc. The tagger 40 can also tag or link the identified information 20 with one or more items of metadata, such as the geographical location, the source of the information, the type of information (e.g., scholarly article, data compiled or provided by a governmental agency, video, etc.), the date on which the information was created or modified, etc. The tagger 40 may also forward the identified information 20 and the metadata to the georeference association system 50 for further processing.

Using the indexer 52, the georeference association system 50 analyzes the metadata and organizes the metadata into index terms. The index terms, which are displayed in the index region 66 of the display 60, generally contain key words or phrases summarizing important aspects of the information and/or geographic location. Similarly, using the depictor 54, the georeference association system 50 analyzes each of the metadata and organizes the metadata into and map symbols. The map symbols, which are displayed in the map 62, generally represent a type of geographic feature found at the geographic location in the map 62. Using the processor 55, the georeference association system 50 associates the metadata with the identified information 20, and may store it in one or more memories (e.g., a look-up table) in the system 50. The georeference association system 50 further displays part (e.g., a summary) or all of the identified information 20 and the metadata in the display 60. Georeference association system 50 may further receive input from a user regarding georeference content (e.g., scholarly articles, authoritative or encyclopedic information, compilations of data from one or more such sources, etc.) to be included in information 20. Processor 55 also displays cartographic and/or geographic information, a search window or function, metadata, and an index or toolkit for performing information management functions on the information in the display 60, the georeference association system 50, the information storage device or system 20, and/or elsewhere in the system 10.

The cartographic and/or geographic information is generally displayed in the map region 62 of the display 60. The search functionality (e.g., a text box and “Search” function button or icon) is generally displayed in the search window, region or tile 64 of the display 60. The index terms, index and/or toolkit are generally displayed in the index region 66 of the display 60. The index terms, index and/or toolkit enable the user to manage and/or manipulate information in or to be displayed in the map region 62 and/or index region 66. For example, the index terms in index region 66 can communicate with (and thus affect the information displayed in) the map symbols in the map region 62 when the index terms and map symbols (or locations or coordinates therein) are linked by the metadata and georeferences. The term “map symbol” refers to a symbol or icon that is shown or displayed on the map to represent the information about the geographic feature or structure at that location. For example, an actual image of the structure or feature is generally not placed on the map. Instead, a symbol (e.g., picture, letter, number, combination of letter[s] and/or number[s], etc.) representing the structure or feature on the map.

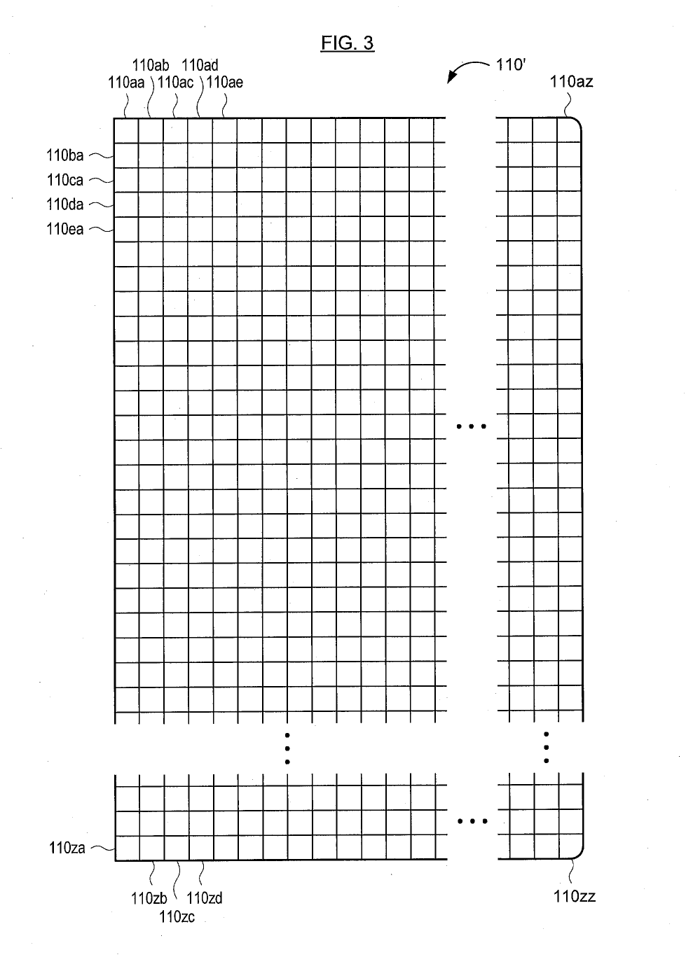

FIG. 2 shows an exemplary user interface 100 suitable for use in the present invention. In general, the exemplary user interface 100 includes map region 110, search region 120, and toolbox region 130. The map region 110 generally displays a two- or three-dimensional map of a particular geographic location (e.g., city, county, area, state, country, etc.) that may be of interest to the user. For example, the map region 110 in FIG. 2 shows a region of central California that includes the cities of Fresno 112 and Visalia 116, and the geographic landmark Millerton Lake 114 along the San Joaquin River 118.

Search window 120 includes a text box 122, one or more index headings 124, and generally a plurality of metadata items or index terms 126a-z. Herein, the term “index term” also includes metadata that is copied or used verbatim as an index term. The text box 122 permits the user to enter one or more search terms. The search algorithm can be based on Boolean logic (e.g., use of linking terms such as “AND,” “OR, “NOT,” etc.), modified Boolean logic (e.g., Boolean logic with alternative or additional capability or functionality, such as use of quotes to indicate a multiword phrase as a search term, wildcard characters to indicate variations in spelling of a search term, truncation characters to indicate all terms that include the characters preceding the truncation character, etc.), or other search algorithm designed to assist the user in identifying information relevant to the topic of their choice.

Index heading 124 may be part of an index (not shown) containing multiple index terms (e.g., 126a-z). The index may be organized and/or arranged according to political region or subdivision, geographical feature, geographical structure, combination thereof, etc. Thus, the index heading 124 may indicate the states, counties, cities, etc. that are shown in the map 110. Alternatively or additionally, the index heading 124 may indicate or include the lakes, rivers, canals or other waterways, mountain ranges, valleys, national parks, etc. that are shown in the map 110. In certain variations, the index headings 124 and/or index terms 126a-z that are displayed in the search window 120 are user-selectable (e.g., from among a list) or user-definable. Users may quickly select and/or focus on a particular type of political region, geographical feature, geographical structure, etc., using an index heading 124 listed in the index.

Index term 126 may also be part of a listing of terms or objects (not shown) that can be seen or explored within a particular index heading 124 of the index. For example, when the index heading 124 is a political region or subdivision, the index term 126 may be a particular geographical locations (e.g., one of a plurality of states, counties, cities, etc.) shown in the map region 110. Such a listing of multiple object terms 126 may be given in alphabetical order, increasing or decreasing size (e.g., by population, area, volume), increasing or decreasing chronological age, number of citations (e.g., to a scientific article or authoritative information source), etc. Users may quickly select and/or focus on a geographical location or feature using an index term 126 listed in the index heading 124.

Index terms 126a-z are a listing of various terms or phrases summarizing and/or representing metadata associated with one or more locations or features shown in the map region 110. Index terms 126a-z may include particular attributes, characteristics, or qualities of the information associated with geographic locations or features on the map 110, such as a larger geographic area or region containing the geographic location (e.g., “Fresno County” for the cities of Fresno 112 and Clovis 113), the source of the information, the type of information (e.g., peer-reviewed technical or scientific article, data compiled or report published by a government agency, video, etc.), the date on which the information was created or modified, etc. Users may quickly sort through, select and/or focus on information having one or more particular attributes, characteristics or qualities by selecting an item listed in the index term list 126a-z.

One way to associate information with a geographic location on a map such as map 110 is to parse or divide the map into a grid or array, assign a given geographic location or feature to one or more areas or regions of the grid or array, then associate a given item of information that is pertinent or relevant to that location or feature either with the location or feature or with the associated areas or regions of the grid or array. FIG. 3 shows an exemplary array 110 divided into z rows and z columns. Depending on the scale of the map, there can be from 1 to 100,000 or more columns, and from 1 to 250,000 or more rows. For example, there may be a minimum of from 2, 4, 8, 10, 16, 20, 25, 32 or more rows and a minimum of from 2, 4, 8, 10, 16, 20, 25, 32 or more columns, up to 100, 128, 1200, 250, 256, 500, 512, 1000, 1028, 2000, 2048, 2500, 4096, 5000, 8192, 10,000, 15,000, 16,000 (from 16,000 to 16,284), 20,000, 25,000, 32,000 (from 32,000 to 32,568) 50,000, or 64,000 (from 64,000 to 65,136) row or columns, or any minimum or maximum number within such endpoints. The numbers of rows and columns may be independent from each other. Also, although squares are shown in FIG. 3, the shapes corresponding to geographic locations on a given map may be rectangular, circular, oval, etc.

Referring back to FIG. 2, a small town such as Orosi 115 may correspond to or be associated with only a single square, and a relatively large city such as Fresno 112 may correspond to or be associated with many adjacent squares. The adjacent squares corresponding to or associated with a relatively large geographic feature may have a regular or irregular shape, and may be one-dimensional (i.e., along a line), two-dimensional, or three-dimensional when the map is three-dimensional.

Alternatively, locations in the map can be defined by a set of coordinates. On a two-dimensional map, the coordinates may be defined by relative distances along two orthogonal axes (e.g., [x,y] coordinates) or a radius (or axis) and arc, and on a three-dimensional map, the coordinates may be defined by relative distances along three orthogonal axes (e.g., [x,y,z] coordinates), two axes (or a radius and an axis) and an arc (e.g., cylindrical coordinates), or an axis (or radius) and two arcs (e.g., spherical coordinates).

Referring back to FIG. 3, the array 110′ may have a scale that is constant when the physical area displayed on the map is relatively constant, but that changes when the physical area displayed on the map changes significantly. For example, the array 110′ can have a scale of 100 squares (in a 10×10 array) per square kilometer on the map 110 (see FIG. 2). The scale of the map 110 can then be any value of from 1 cm=10 km to 1 cm=0.1 km (or any range therein, such as from 0.5 km to 5 km), and the physical locations or features on the map 110 and the associated metadata (all of which are correlated to or associated with one or more squares in the array 110′, FIG. 3) can remain associated with the information corresponding to or associated with those physical locations or features at the scale of the particular array 110′. However, if the scale of the map 110 changes significantly (e.g., to a value of from 1 cm=1000 km to 1 cm=10 km (or any range therein, such as from 20 km to 200 km), then the array 110′ may have a scale of 100 squares (in a 10×10 array) per 100 square kilometers on the map 110. At such a scale, an appreciable amount of information that is associated with a relatively small number of squares (e.g., 5 or less, more typically 4 or less) when the array scale is 100 squares per square kilometer will generally not be available when the array scale is 100 squares per 100 square kilometers. However, it is possible that much of the information associated with one or more squares when the array scale is 100 squares per 100 square kilometers will be available when the array scale is 100 squares per square kilometer. Typically, only that information that is associated with a relatively large proportion of the squares (e.g., ≧5%, ≧10%, ≧20%, or any other value that is determined based on the map size and dimensions, the array scale, any applicable change in the array scale when the map scale changes, etc.) in an array in a map that covers a relatively large area will generally not be available when the scale of the map is changed to a relatively small area.

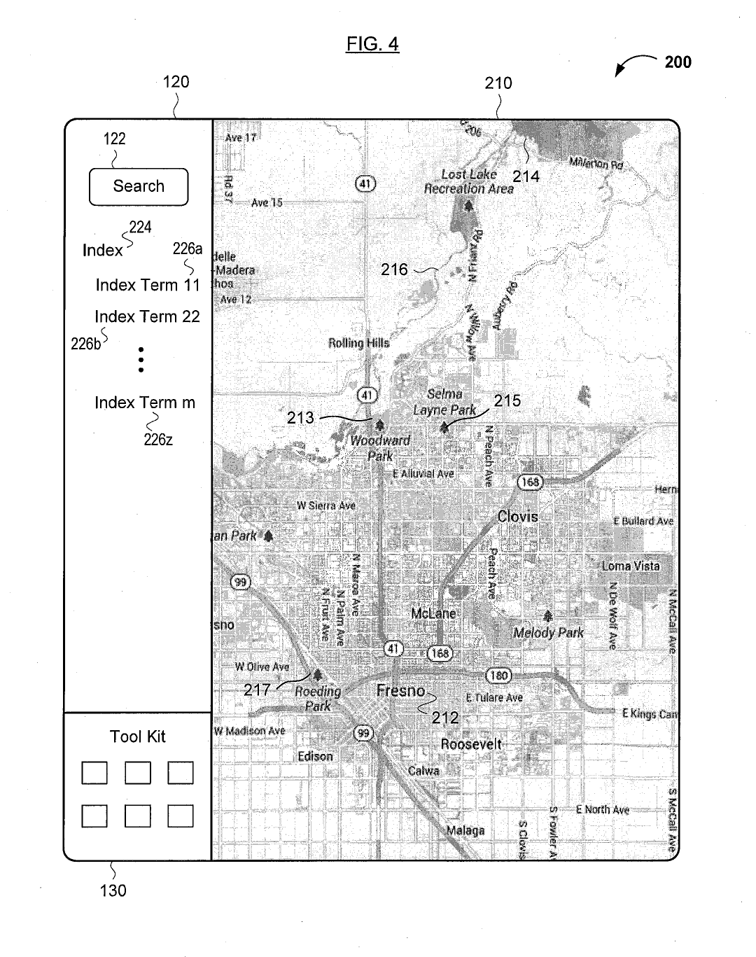

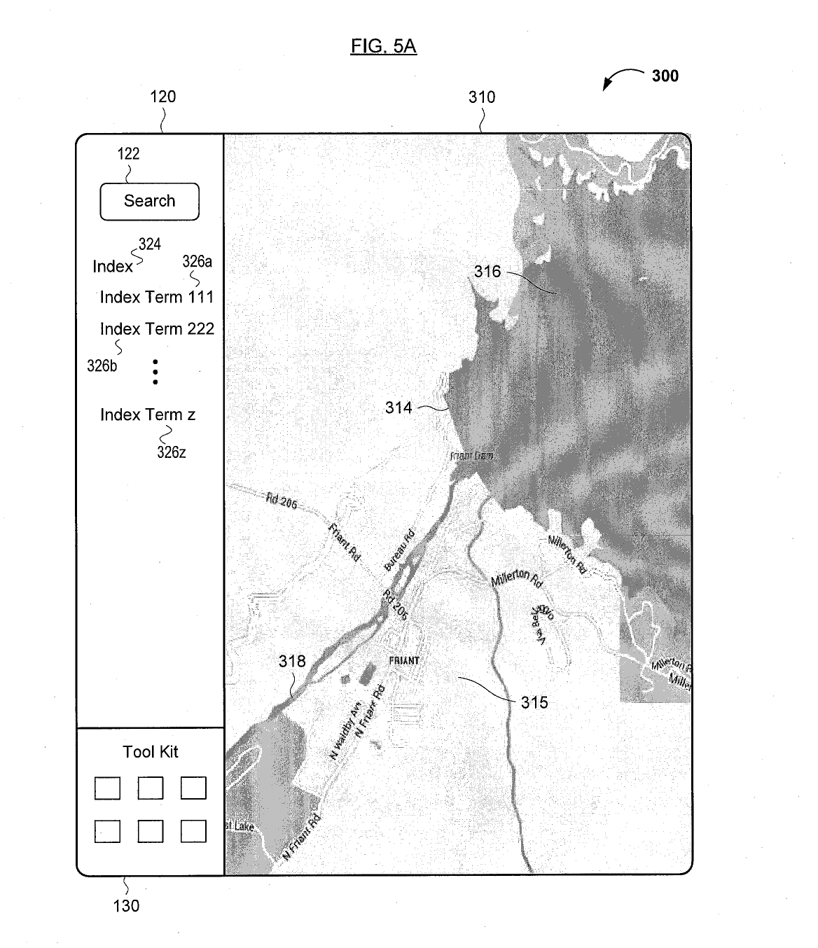

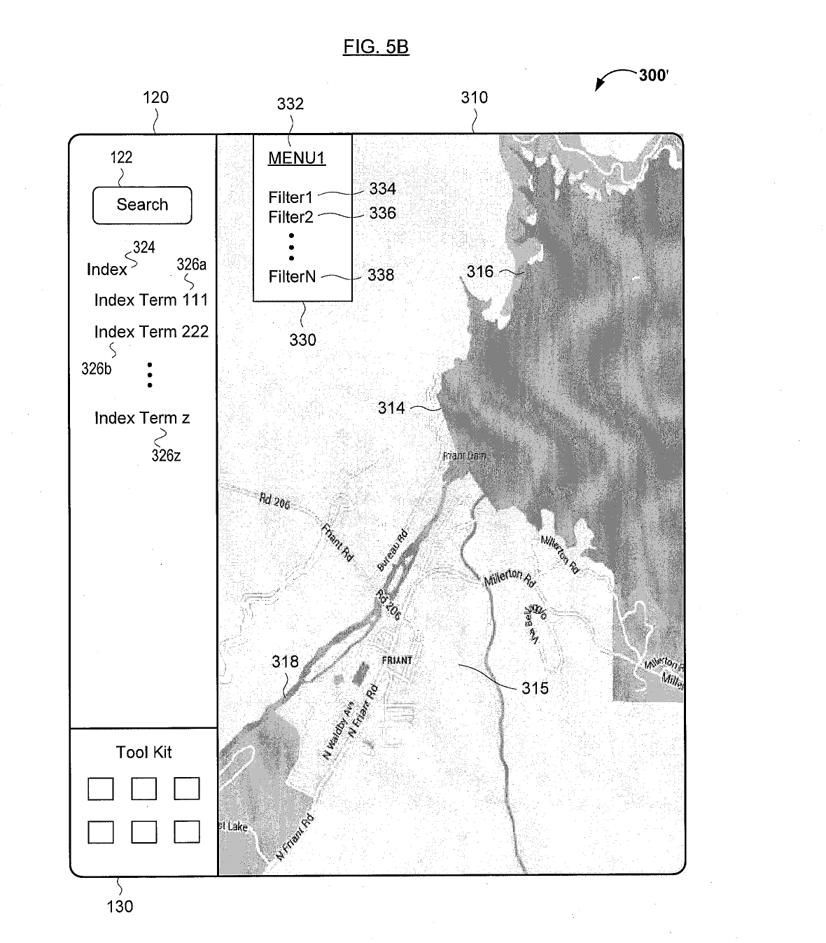

FIG. 4 shows another exemplary user interface 200 suitable for use in the present invention. The exemplary user interface 200 includes map region 210, search region 120, and toolbox region 130. The map region 210 displays a portion of the map 110 of FIG. 2, zoomed in on the city of Fresno 212 and the area to the north of Fresno, including a portion of the San Joaquin River 216 and a portion 214 on Millerton Lake. Although the search region 122 and the toolbox or toolkit 130 are generally the same in both FIGS. 2 and 4, the index heading(s) 224 and index terms 226a-z are generally different.

For example, public parks such as Woodward Park 213, Selma Layne Park 215 and Roeding Park 217 now have a size in map 210 that enables association of geospatial information with the locations of the parks on the map 210, and thus display of such information on the map 210. The locations of these parks, as well as the information available through the geographic search portal, may be represented by a map symbol such as a tree. The map symbols may also represent and/or perform one or more information management and/or manipulation functions when selected by the user. In the map 110 of FIG. 2, these public parks do not have a sufficient size to enable association of geospatial information about the parks with the locations of the parks (which are not visible in the map 110 of FIG. 2). As a result, the user cannot obtain geospatial information about such public parks in the map 110 of FIG. 2.

However, the user can obtain more detailed geospatial information about the displayed portions of the San Joaquin River 216, such as average flow rate at a particular location, average width at a particular location, number and species of fish observed at a particular location, particular toxins or chemicals (e.g., pesticides, fertilizers, bacteria, etc.) measured at a particular location, etc., using map 210, as opposed to map 110 in FIG. 2. This is because the scale of the array underlying or associated with map 210 in FIG. 4 has changed relative to that of map 110 in FIG. 2, enabling more detailed information about smaller geographic locations and features to become available to the user.

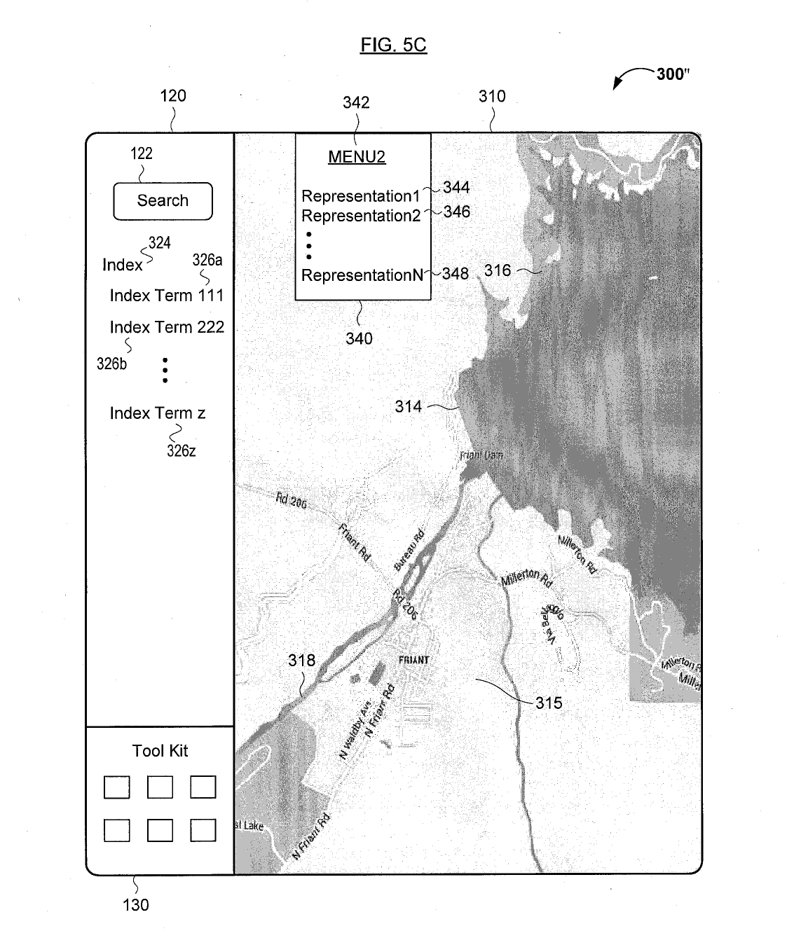

FIG. 5A shows yet another exemplary user interface 300 suitable for use in the present invention. The exemplary user interface 300 includes map region 310, search region 120, and toolbox region 130. The map region 310 displays a portion of the map 210 of FIG. 4, zoomed in on the area around the geographic landmark Friant Dam 314 adjacent to Millerton Lake 316. Although the search region 122 and the toolbox or toolkit 130 are generally the same in FIGS. 2, 4 and 5A, the index heading 324 and index terms 326a-z are generally different from that displayed in FIGS. 2 and 4, for substantially the same reasons as discussed above with regard to FIG. 4. In the exemplary user interface 300 of FIG. 5A, using the index heading 324 and/or index terms 326a-z, a user may be able to obtain detailed geographic or other location-based information about a particular physical location or feature shown on the map 310, in the same way as in FIGS. 2 and 4.

For example, clicking on (or otherwise selecting) Friant Dam 314 will display index terms pertaining to technical, scholarly, encyclopedic, factual or archival information and/or studies about the actual Friant Dam, such as flow rate data published by local, state or Federal government agencies or bureaus, numbers and types of fish (such as salmon) found at Friant Dam, historical data relating to Friant Dam, etc. Clicking on or otherwise selecting Friant Dam 314 may also display in the map region 310 certain well-known, generally recognized, uncontroversial information relating to Friant Dam, such as its date of construction and its geographic location (e.g., the state and the nearest city or town, Friant, Calif.). Clicking on (or otherwise selecting) the town of Friant 315 will display index terms pertaining to technical, scholarly, encyclopedic, authoritative, educational, factual or archival information and/or studies about the town of Friant, such as its population over time, its founding and factual history, factual information about famous persons in Friant (e.g., Olympic snowboarder Andy Finch), etc. Clicking on or otherwise selecting Friant 315 may also display certain well-known, generally recognized, uncontroversial information relating to Friant, such as its current or most recent population.

Relative to the map 210 of FIG. 4, the user can obtain more detailed geospatial information about the displayed portions 318 of the San Joaquin River, the town of Friant 315, etc., using map 310 in FIG. 5A as opposed to map 210 in FIG. 4. Again, this is because the scale of the array underlying or associated with map 310 in FIG. 5A has changed relative to that of map 210 in FIG. 4, enabling more detailed information about smaller geographic locations and features to become available to the user.

FIG. 5B shows a further exemplary user interface 300′ suitable for use in the present invention. The exemplary user interface 300′ includes substantially the same map region 310, search region 120, and toolbox region 130 as in FIG. 5A, but the interface 300′ now displays a first pull-down menu 330. The pull-down menu 330 has a heading 332 (e.g., “Geographic Features”) and lists a number of information filtering criteria, the selection of which will limit or restrict the map symbols displayed in the map region 310, and the index heading 324/index terms 326a-z. For example, “Filter1” may be a filtering term such as “Cities/Towns,” the selection of which limits the information displayed in the map region 310 and/or index term(s) 326a-z to only cities and towns in the map region 310. The index terms 326a-z will then be limited to technical, scholarly, encyclopedic, authoritative, educational, factual or archival information about the cities and towns in the map region 310. The filtering terms Filter1-FilterN 334-338 (or a subset thereof) can further include a population threshold (e.g., “Cities>1,000,000 pop.,” “Towns 10-100K pop.,” etc.).

In addition, “Filter2” may be a filtering term such as “Water Bodies,” the selection of which limits the information displayed in the map region 310 and/or index heading 324/index terms 326a-z to only bodies of water in the map region 310. The index terms 326a-z will then be limited to technical, scholarly, encyclopedic, authoritative, educational, factual or archival information about the water bodies in the map region 310. The filtering terms Filter1-FilterN (or a subset thereof) can further include a type of water body (e.g., “Lakes,” “Rivers,” “Canals,” “Dams,” “Wells,” “Underground Waterways,” etc.). Alternatively, the filtering terms Filter1-FilterN can include historical terms such as founding date, original settlement date, incorporation date, etc.; demographic terms such as population, average annual growth rate, growth rates over predetermined periods of time (e.g., over the last year, last decade, from 1930 to 1940, etc.), ethnicity or religious background, employment rate, occupations, etc.; land use terms, such as zoning, reported use(s) of the land, etc.; other land-based criteria, such as ownership, public financing, indebtedness (e.g., amount of money borrowed against a particular parcel or region of land), etc.; and others.

FIG. 5C shows a still further exemplary user interface 300″ suitable for use in the present invention. The exemplary user interface 300″ includes substantially the same map region 310, search region 120, and toolbox region 130 as in FIGS. 5A-B, but the interface 300″ now displays a second pull-down menu 340 with a second heading 342 (e.g., “Display Type”). Thus, the present user interface may include one or more pull-down menus or other lists of selectable terms or topics of geographic and/or location-based interest. The second pull-down menu 340 lists a number of representation types or formats for the map 310, the selection of which will change the display in the map region 310 to a particular type or format. For example, “Representation1” 344 or a subset of the terms Representation1-RepresentationN 344-348 may include a term or terms such as “2-D” or “3-D,” the selection of which displays the map region 310 and/or the information therein in two dimensions or 3 dimensions, respectively. The index terms will generally not change, unless a particular selection (e.g., “3-D”) increases or decreases the amount of available information (e.g., correlated to or associated with an underlying array).

Furthermore, “Representation2” 346 (or a different subset of the terms Representation1-RepresentationN 344-348) may include a term such as “Topographical Relief,” the selection of which displays geographic information in the map region 310 in topographic relief. The terms Representation1-RepresentationN 344-348 (or a subset thereof) can further include other display formats, such as color coding (e.g., based on population density, land use [e.g., agriculture, manufacturing, residential, light or heavy commercial, etc.], land type [e.g., mountains, valleys, forest or type of forestation, desert, etc.], average rainfall, average temperature, etc.). Many other types or formats for displaying geographic information in the map region 310 can be easily implemented by those skilled in the art.

An Exemplary Method of Making or Designing a Geospatial Search Portal

In another aspect, the present invention concerns a method of setting up, designing, creating, providing, making and/or designing (hereinafter, “creating”) a geospatial search portal, comprising importing or creating an electronic map having electronic locations or features thereon, identifying and/or retrieving scholarly, technical, encyclopedic, factual, and/or archival information, tagging each of the scholarly, technical, encyclopedic, factual, and/or archival information with georeferences and metadata, linking the georeferences with electronic locations or features on the electronic map, analyzing and organizing each of the metadata into index terms and/or map symbols, and configuring a processor to display at least some of the scholarly, technical, encyclopedic, factual, and/or archival information when one or more corresponding electronic location(s) or feature(s), georeferences, metadata, index terms, and/or map symbols are electronically selected. As for the present geospatial search portal, the information is generally scholarly, technical, encyclopedic, factual and/or archival, rather than commercial or advertisement-related. In general, the information linked to the electronic locations on the map includes content that can be verified (e.g., using reliable sources).

The electronic map having electronic locations or features thereon can be created by one skilled in the art using known techniques and technology. However, it may be easier to import or license the electronic map from a known source (e.g., electronic maps from a search engine, such as Google®, Yahoo®, Bing®, etc.; from a software provider such as Microsoft; from a global positioning satellite [GPS] software and/or service provider, such as Magellan, Garmin, etc.). Such maps generally have names of many actual geographic locations and features represented electronically thereon, and generally at a number of different scales or levels of granularity. For example, in an electronic map representing the United States, names of states having a certain minimum threshold area and names of cities having a certain minimum threshold population for a given population density will be electronically represented and displayed on the map, but others are not. More specifically, the names “California” and “Texas” are displayed in the electronic map of the U.S., but the names “Delaware” and “Rhode Island” are not. Also, the names of cities having a population of at least one million in a region of the U.S. having a population density of more than 50 persons per square mile, or a population of at least one hundred thousand in a region of the U.S. having a population density of less than 5 persons per square mile, are displayed in the electronic map of the U.S., but the names of other cities are not. However, in an electronic map of the Fresno metropolitan area (see, e.g., FIG. 4), the names of substantially all incorporated cities, of towns having a certain minimum threshold population or age, of certain major streets and thoroughfares, of parks having a certain minimum threshold area, and of significant geographic features (such as rivers, lakes, creeks and other waterways having a minimum size or flow, mountains having a certain minimum height, etc.) may be electronically represented and displayed, although the names of larger locations (such as California and the United States) are not.

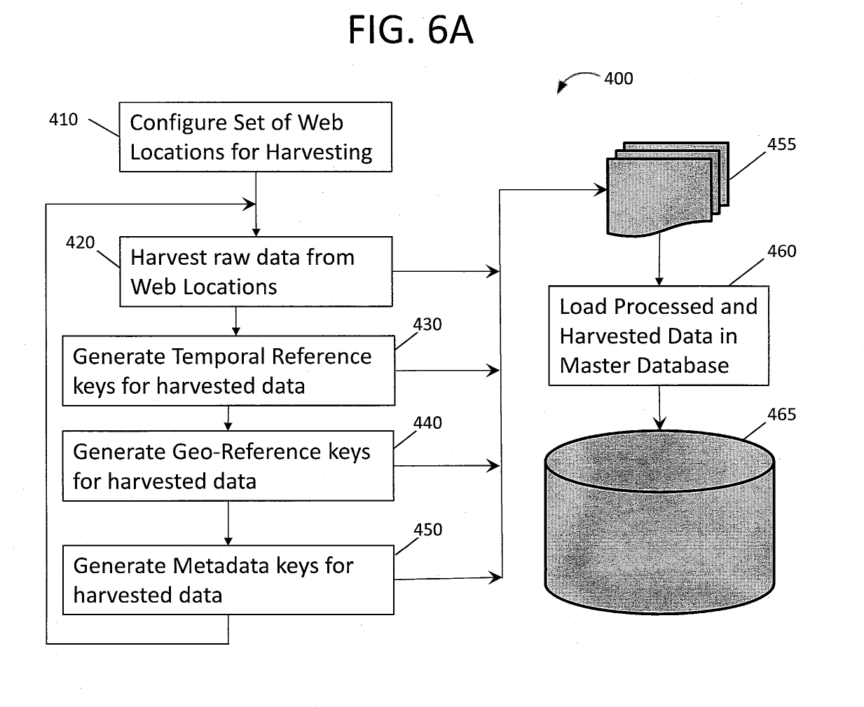

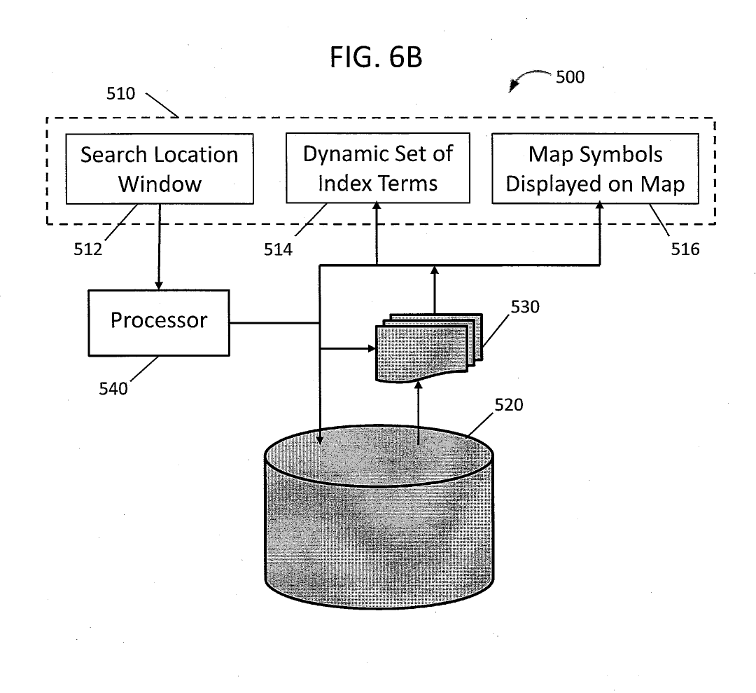

Referring now to FIG. 6A, a flow chart 400 depicting an exemplary method of harvesting data and/or information for a geospatial search portal is shown. At least part of the method of harvesting data and/or information creates keys for linking the information relating to actual geographic locations or features to the electronic locations or features on the electronic map. Thus, the method of harvesting data and/or information shown in FIG. 6A is an important part of the exemplary process of designing and/or implementing the geospatial search portal.

At 410, the method configures and/or identifies a set of World Wide Web (Internet) locations that include scholarly, technical, encyclopedic, factual and/or archival information for harvesting. For example, Internet sites of universities, government agencies or bureaus, publishers of technical, encyclopedic, factual scientific, educational and/or scholarly literature, or other organizations that publish factual and/or verifiable information about geographic locations and/or features can be identified, and links to their sites (and/or to sites therein where such information is stored and/or published) can be made.

At 420, raw data or other information at the identified sites is harvested (e.g., by an information harvester 30 in FIG. 1). Harvesting raw data and/or information may include temporarily storing the addresses of the identified sites, the information stored or published at those sites, and links correlating the addresses of particular sites with the information stored or published at those sites.

At 430, temporal reference keys are generated for the harvested data/information. For example, a publication date may be associated with or further linked to each of the addresses of the identified sites containing the harvested data and/or information at 430. At 440, geo-reference keys are generated for the harvested data/information. For example, one or more names of the actual geographic location or feature may be associated with or further linked to each of the addresses of the identified sites containing the data and/or information harvested for that particular geographic location or feature at 440. At 450, metadata keys are generated for the harvested data/information. For example, basic terms or short phrases describing and/or identifying particular data/information, such as the subject, keywords, title (in part or in its entirety), author, publisher, etc. of the data/information, may be associated with or further linked to the address of the identified site containing the particular data and/or information at 450.

It is not necessary to perform the actions or activities at 430-450 in any particular sequence. In fact, the action or activity(ies) at 430 is/are not required (e.g., if a temporal reference for particular information or data cannot be found or verified). Performing the actions or activities at 430-450 results in production of harvested and processed data and/or information 455, which is then used in the geospatial search portal.

At 460, the harvested and processed data and/or information 455 are loaded in a master database 465. The master database 465 includes a database of the various temporal reference keys, geo-reference keys, metadata keys, index term keys, and map symbol keys, generated at 430-450, which may be stored as a list or table of keys, tags, pointers, etc. In some embodiments, the data and/or information is also stored in the master database 465. The master database 465 may take any of a number of physical and/or virtual forms, such as one or more hard disk drives, redundant arrays of independent disks (RAIDs), data storage farms, and/or cloud-based storage systems and/or services.

FIG. 6B is a diagram 500 showing an exemplary system for displaying the harvested and processed data and/or information in a geospatial search portal. At least part of the system for displaying the harvested and processed data and/or information configures a processor to display at least some of the information relating to one or more particular actual geographic locations or features when corresponding electronic location(s) or feature(s) are electronically selected on the electronic map. Thus, the system for displaying the harvested and processed data and/or information shown in FIG. 6B implements an important part of the exemplary process of designing and/or implementing the geospatial search portal.

The exemplary data and/or information display system 500 includes display device 510, master database 520, data and/or information cache 530, and processor 540. The display device 510 displays a search location and/or window 512, a dynamic index including a dynamic set of index terms 514, and a main map display 516. The main map display 516 displays the electronic map discussed generally herein, with one or more map symbols (not shown) thereon. The search location and/or window 512 is a region in the display of display device 510 that displays a text box or similar feature for entering search terms and an icon that, when clicked or otherwise selected, initiates a search function in the master database 520 and/or data/information cache 530. The search function may be executed and/or controlled by the processor 540.

In one exemplary process, information can be displayed in the main map display 516 in accordance with the configuration of the processor 540. For example, the processor 540 may receive search or query terms, strategy and/or logic entered by the user in search window 512, then initiate a search for information, index terms, and/or metadata containing such terms, variants thereof (in accordance with conventional Boolean, non-Boolean [e.g., “smart”], or “natural language” search or query logic), or other responsive information stored in or linked to the master database 520. Alternatively, software and/or logic not included within the processor 540 (e.g., within software and/or hardware controlling the interface for the display device 510 and/or the master database 520) may conduct such a search. Information, index terms, and/or metadata matching the search terms, strategy and/or logic is then retrieved, transferred or copied from the master database 520 and stored at least temporarily in the data/information cache 530. The data/information cache 530 may be a conventional data buffer (e.g., a dual-port memory, first-in-first-out buffer, disk buffer, UART buffer, etc.).

The retrieved information stored in the data/information cache 530 is then displayed by the display device 510 in response to one or more commands from the processor 540. For example, new index terms may appear in the dynamic index/index terms region 514 of the display, and new map symbols, data and/or other information may appear in the main map display 516. In some embodiments, a summary of and/or link to the data and/or information is displayed in the main map display 516. The user can then select (e.g., by clicking on) the summary and/or link to obtain the source information.

Exemplary Methods of Using a Geospatial Search Portal

The present invention further relates to a method of finding information relating to an actual geographic location, comprising searching for information using a geospatial search portal, viewing retrieved information, and optionally, exporting (e.g., storing, transferring, emailing, etc.) or printing at least some of the retrieved information. The geospatial search portal comprises an electronic map having one or more electronic locations thereon. The information generally includes scholarly, technical, encyclopedic, factual, and/or archival information electronically associated with and/or linked to each of the electronic location(s). The information generally relates to an actual location represented by a corresponding electronic location on the electronic map. The geospatial search portal also comprises logic that analyzes the metadata and organizes the metadata into index terms and/or map symbols, a user interface configured to display the electronic map, a predetermined and/or identified electronic location on the electronic map, and at least some of the scholarly, technical, encyclopedic, factual, and/or archival information relating to the actual location when the identified and/or corresponding electronic location on the electronic map is electronically selected;

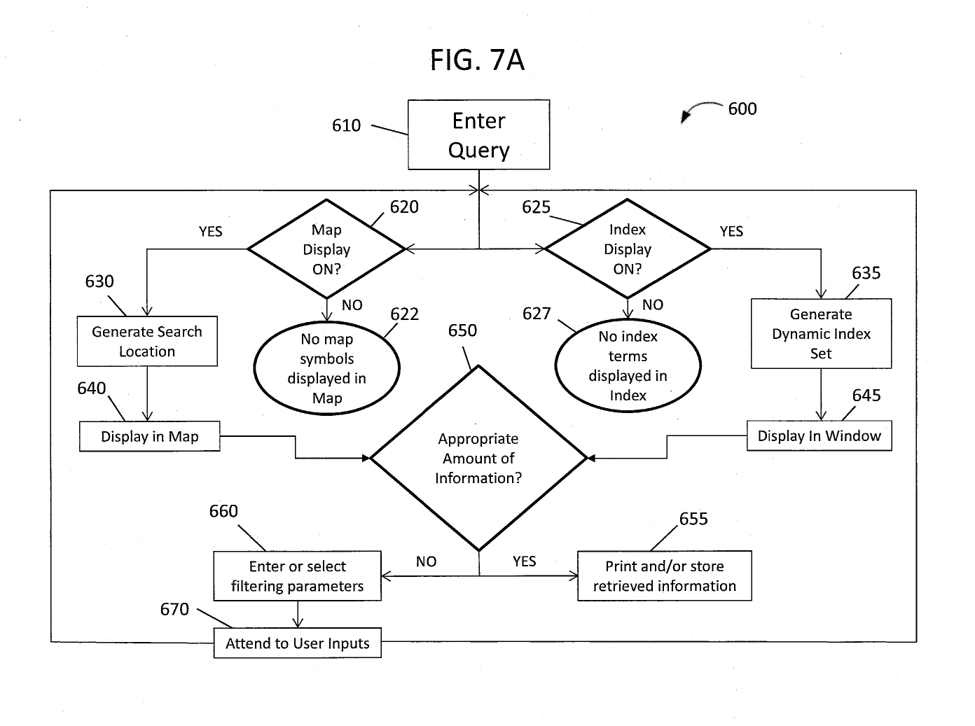

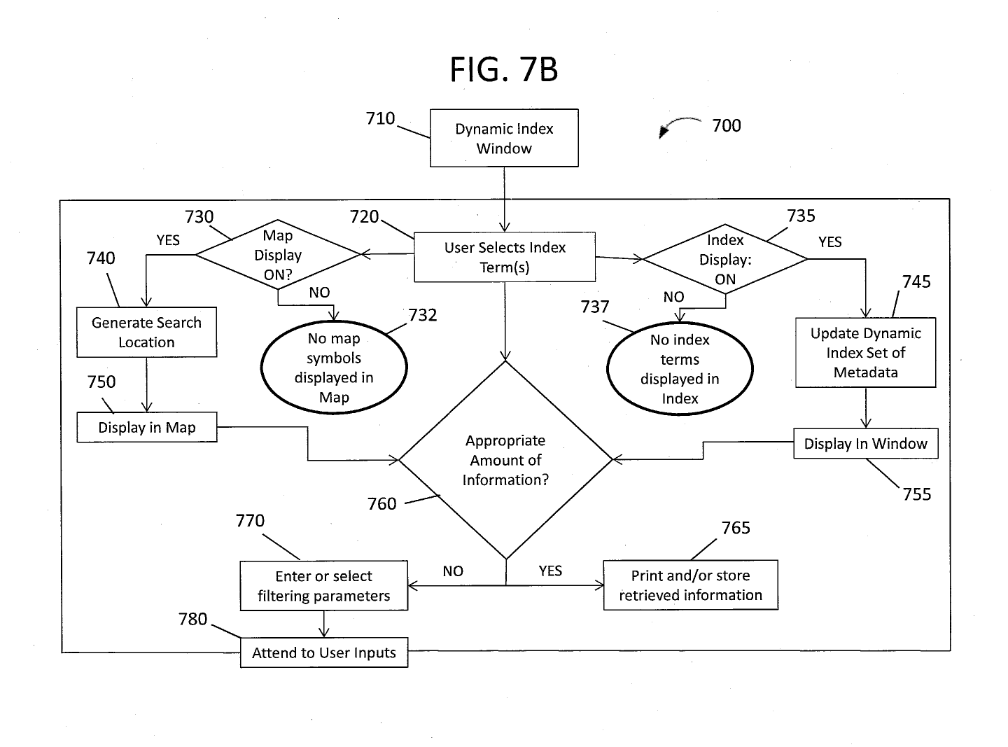

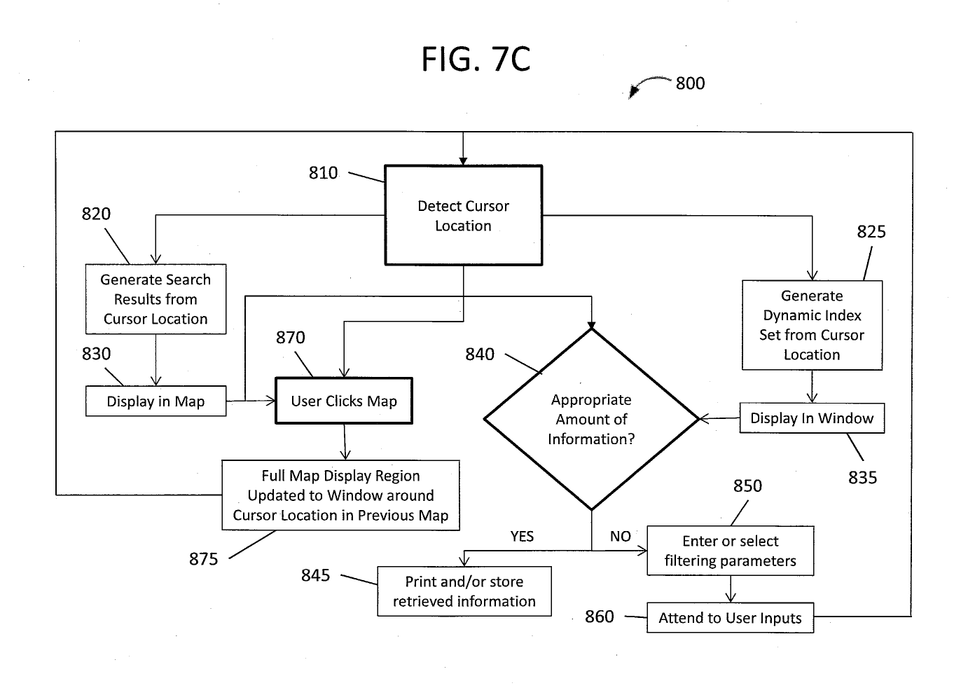

FIGS. 7A-C are flow charts for exemplary methods of using a geospatial search portal to find relevant scholarly, technical, encyclopedic, factual, and/or archival information about a particular location in accordance with the present invention, including a text-based search method (FIG. 7A), a selection method based on a dynamic index window (FIG. 7B), and a displayed term selection method (FIG. 7C. The dynamic index window generally contains index terms, and may contain buttons, icons, symbols, etc., linked to such information. Similarly, map symbols displayed in the main map region (e.g., 66 in FIG. 1, 110 in FIG. 2, 210 in FIG. 4, 310 in FIGS. 5A-C, and 516 in FIG. 6B) may also be linked to such information.

Referring to FIG. 7A, a flow chart 600 is shown for a text-based method of searching scholarly, technical, encyclopedic, factual, and/or archival information about a particular geographic location or feature. At 610, a user enters a query, generally in a search box or search window similar to the text box 122 in FIGS. 2 and 4 and/or the search window 512 in FIG. 6B. The query generally takes the form of one or more terms contained in the information sought by the user. When the user enters multiple terms, they may be linked using Boolean operators (e.g., AND, OR, NOT, etc.) or non-Boolean operators, they may be limited to certain fields of the information (e.g., in the Title or Abstract), they may take the form of natural language, or they may be combined in accordance with any conventional search language, search engine, etc.

Next, the geospatial search portal determines whether the map display is on at 620 and whether the index display is on at 625. More specifically, a processor in the geospatial search portal may perform the determinations and/or functions at 620 and 625. Generally, both the map display and the index display are on in the geospatial search portal, but there may be circumstances (e.g., when the user is using a mobile device with limited power supply) when one of the map display and the index display is off. If the map display is off at 622, then no map symbols (and, for example, no information as described in the preceding paragraph) is displayed in the map display region (e.g., the electronic map), and the user must rely on the process 635, 645, 660 and 675 in the index display region to search for and locate relevant information. If, on the other hand, the index display is off at 627, then no index terms are displayed in the index display region, and the user must rely on the process 630, 640, 660 and 670 in the map display region to search for and locate relevant information.

However, if the map display is on, then at 630, locations pertinent and/or responsive to the query/search are generated and/or identified, then at 640, such locations are displayed in the electronic map. In addition, certain terms and/or information summaries may be displayed in the electronic map, which may be linked to the source information (e.g., stored in the master database), and if so, the user may display desired source information by selecting (e.g., clicking on) the corresponding term or information summary.

Similarly, if the index display is on, then at 635, a set of terms and/or metadata pertinent and/or responsive to the query/search are generated and/or identified for a “dynamic” index, then at 645, such terms and/or metadata are displayed in the index region of the display. In addition, icons, buttons and/or other objects may be displayed in the index region of the display. Such terms, metadata, icons, buttons and/or objects may be linked to the source information (e.g., stored in the master database), to summaries and/or further metadata of the source information, and/or to compilations of the source information, etc. (see the discussion of FIG. 7B below). If so, in one embodiment of the present geospatial search portal, the user may display desired source information (or summaries, further metadata, etc.) by selecting (e.g., clicking on) a term, metadata, icon, button or other object corresponding to the desired source information. This function may be implemented using a “retrieve source information” function icon in too kit 130 (see FIGS. 2, 4, and 5A-C). Although index terms only may be shown in the Index, and metadata analyzed and categorized by the Indexer, metadata may be shown in the Index as one or more index terms (e.g., one or more metadata may be copied and used as an index term or index terms).

Regardless of whether the map display is on, the index display is on, or both are on, the user determines at 650 whether an appropriate amount of information is displayed in the map display and/or index display region(s). If so, the user may retrieve the identified source information as described herein, then print and/or store the retrieved information at 655. The user can now go back to 610 and enter a new query or search, or refine or enlarge the query or search performed. Alternatively, if the user has seen, printed, stored and/or otherwise collected sufficient information (at least for the time being), the method may end.

However, if the user determines at 650 that an appropriate amount of information is not displayed in the map display and/or index display region(s), at 660, the user may enter additional search/query terms in the search window (e.g., the text box 122 in FIGS. 2 and 4 and/or the search window 512 in FIG. 6B). Alternatively or additionally, the user can select filtering parameters and/or functions (e.g., using certain terms and/or metadata in the index display region [FIG. 7B], or using icon- or button-based filtering functions that may be displayed in a function display region such as tool kit 130 in FIGS. 2, 4 and 5A-C), or can simply zoom in, zoom out, or shift the map in a particular direction or directions. At 670 and 675, the processor(s) for the map display and the index display, respectively, attend to the user input(s). Thereafter, the method 600 returns to 620 and 625 to repeat the flow and/or some or all of the process(es) therein. Thus, when the index display is on at 625, the information in the index display is modified, changed or updated, and can therefore be thought of as being “dynamic.”

The determinations and/or functions 620, 630, 640, 660 and 670 performed in the map display region are generally conducted independently from the determinations and/or functions 625, 635, 645, 660 and 675 performed in the index display region. Thus, different processors may be configured to perform or control the separate determinations and/or functions, or, a single processor can be configured to perform or control the map display and index display determinations and/or functions independently, when it has such capability.

FIG. 7B shows a flow chart 700 for a metadata-based method of refining a search for scholarly, technical, encyclopedic, factual, and/or archival information about a particular geographic location or feature. At 710, a user reviews index terms and/or metadata displayed in a “dynamic” index display of the present geospatial search portal. The index terms and/or metadata are generally generated and identified in a search performed in accordance with 610, 625, 635 and 645 in FIG. 7A.

At 720, the user selects one or more index terms displayed in the index window or display to filter or refine (1) the information displayed in the map region and/or (2) the source information to be retrieved from the master database. Alternatively or additionally, the index window or display region may display metadata, icons, buttons and/or other objects that may be linked to source information (e.g., stored in the master database), to summaries and/or further metadata of the source information, and/or to compilations of the source information, etc. The user may filter or refine the displayed and/or retrieved index terms by selecting (e.g., clicking on) a term, metadata, icon, button or other object corresponding to the desired filtering parameter. For example, an index term reciting the author, publisher, source, publication year, etc., can be used to filter the information displayed in both the index window (e.g., at 745) or in the map region (e.g., at 732) to information from that author, publisher, source, publication year, etc. If the user wishes to see a map of agricultural land use in a particular area, the user may select an index term representing the “US Dept. of Agriculture” as the source of land use information, and see such information displayed in the electronic map. If the user wishes to limit such information to a particular year, an index term representing a particular calendar year may be selected. The same principles can be used to filter or refine the source information retrieved by the geospatial search portal. The potential uses and applications of index terms and/or metadata for filtering or refining search results are practically limitless.

After the user selects certain index term(s), the geospatial search portal determines whether the map display is on at 730 and whether the index display is on at 735 in the same or substantially the same way as at 620 and 625 in FIG. 7A. In general, in the method 700, because an index term is selected, the index display is generally on at 735. Also, when the map display is on at 730, information is generated at 740 and displayed in the electronic map at 750 in the same or substantially the same way as at 630-640 in FIG. 7A. However, when the index display is on at 735, the dynamic set of index terms (and, if present, metadata, buttons, icons, etc.) in the index display are updated at 745 with one or more new terms from the filtered and/or refined information, and the updated index terms are displayed in the dynamic index window at 755.

Thereafter, the user determines at 760 whether an appropriate amount of information is displayed in the map display and/or index display region(s) in the same or substantially the same manner as at 650 in FIG. 7A. If so, the user may retrieve the identified source information as described herein, then print and/or store the retrieved information at 765. The user can go back to 720 and select one or more new or different index terms, or end the method, as may be desired.

However, if the user determines at 760 that an appropriate amount of information is not displayed in the map display and/or index display region(s), then at 770, the user may select different or additional filtering parameters and/or functions (e.g., using index terms or icon- or button-based filtering functions that may be displayed in a function display region such as tool kit 130 in FIGS. 2, 4 and 5A-C). Alternatively, the user can simply zoom in, zoom out, or shift the electronic map in a particular direction or directions. At 780 and 785, the processor(s) for the map display and the index display, respectively, attend to the user input(s) in the same or substantially the same manner as at 670 and 675 in FIG. 7A. Thereafter, the method 700 returns to 720 to repeat the flow and/or some or all of the process(es) therein. Thus, when the index display is on at 735, the information in the index display is updated, changed or modified, and is therefore “dynamic.”

FIG. 7C shows a flow chart 800 for a method of refining a search for scholarly, technical, encyclopedic, factual, and/or authoritative information about a particular geographic location or feature using a predefined area or “window” around the cursor location on the electronic map of the present geospatial search portal. This method or feature of the present geospatial search portal can be activated automatically or using a button or icon in the tool kit 130 (e.g., FIG. 2) or a menu item in a pull-down menu (e.g., 320 in FIG. 5B).

At 810, a processor in the geospatial search portal detects the cursor location on the electronic map. In the method 800 of FIG. 7C, the processor also defines a window, or area having predefined or user-selectable dimension(s), surrounding the cursor location. For example, when the electronic map displays a geographic area of 100 km×200 km, the window may be a circle having a radius of 1-10 km (e.g., 5 km) surrounding the cursor location. Alternatively, when the electronic map displays a geographic area of 1 km×1 km, the window may be a square having a length and width of 100 m, with the cursor location at the center. Many other window shapes, dimensions and relative proportions can be easily imagined and implemented by those skilled in the art. In the exemplary method 800, the cursor location (and, optionally, the window around the cursor location) operates as a search term, and retrieves information pertinent and/or responsive to the geographic location specified by the cursor. Thus, information pertinent and/or responsive to that geographic location (such as names, summaries of historical, geographic and/or demographic information, etc.) is generated at 820 and displayed in the electronic map at 830, and index terms pertinent and/or responsive to that geographic location are generated at 825 and displayed in the dynamic index at 835.

At substantially any time, the user may determine at 840 whether an appropriate amount of information is displayed in the map display and/or index display region(s), in the same or substantially the same manner as at 650 in FIG. 7A and/or 760 in FIG. 7B. If so, the user may retrieve the identified source information as described herein, then print and/or store the retrieved information at 845. The user can go to 850 and select new or different filtering parameters (e.g., index terms), move the cursor to change the displayed information or conduct a new geospatial search, or end the method, as may be desired.

If the user determines at 840 that an appropriate amount of information is not displayed in the map display and/or index display region(s), then at 850, the user may select different or additional filtering parameters and/or functions in the same or substantially the same manner as at 650 in FIG. 7A and/or 760 in FIG. 7B, or the user can move the cursor to change the displayed information or refine the search. Alternatively, the user can zoom in, zoom out, or shift the map in a particular direction or directions, any of which may also change the location or position of the cursor and/or the window surrounding the cursor. At 860, the processor(s) for the map display and/or the index display attend to the user input(s) in the same or substantially the same manner as at 670 and 675 in FIG. 7A. Thereafter, the method 800 returns to 810 to detect the location and/or position of the cursor and repeat the flow and/or some or all of the process(es) therein.

However, at substantially any time, the user may determine at 870 that the cursor is in a location of geographic interest, and can automatically zoom in to the window surrounding the cursor by clicking on the electronic map at 870. Thus, at 875, the processor for the map display changes or updates the map display to the predefined or user-selected window around the cursor location in the previous map, thereby bringing a new and deeper level of detailed information to the user. The user can then change geospatially search the new map using the cursor to locate, identify and/or retrieve scholarly, technical, encyclopedic, factual, and/or authoritative information about locations in the new, more detailed electronic map. The window surrounding the cursor now changes its dimension(s) to fit the scale of the new electronic map. In embodiments implementing the cursor-based search and the cursor window-based zoom functions, the user may deselect such functions using a corresponding button or icon in the tool kit 130 (e.g., FIG. 2) or a corresponding menu item in a pull-down menu (e.g., 320 in FIG. 5B).

Exemplary Software for a Geospatial Search Portal

A further aspect of the invention relates to a computer program and/or software, implementable and/or executable in a general purpose computer or workstation or other electronic apparatus equipped with conventional digital and/or analog signal processor(s) (e.g., microprocessor, microcontroller, DSP, etc.), configured to perform one or more steps of the method and/or one or more operations of the hardware. Consequently, a further aspect of the invention relates to software that implements the above method. For example, the invention may further relate to software and/or a tangible computer-readable medium containing a set of instructions which, when executed by an appropriate signal processing apparatus, is configured to perform the method of monitoring physical activity described herein. The computer-readable medium may comprise any (tangible) medium that can be read by a signal processing apparatus configured to read the medium and execute code stored thereon or therein, such as a floppy disk, CD-ROM, magnetic tape or hard disk drive. Such code may comprise object code, source code, and/or binary code.

The code is generally configured for transmission through an appropriate medium, such as copper wire, a conventional network cable, a conventional optical data transmission cable, or even air or a vacuum (e.g., outer space) for wireless signal transmissions. The code is generally digital, and is generally configured for processing by a conventional digital data processor (e.g., a microprocessor, microcontroller, or logic circuit such as a programmable gate array, programmable logic circuit/apparatus or application-specific [integrated] circuit).

Specifically, in various exemplary embodiments, the method, and variations thereof, may be accomplished by a computer-readable medium comprising computer-executable instructions that is adapted to perform the various steps of the method. For example, the computer-executable instructions may be adapted to instruct one or more users to tap and/or rotate an associated training module, determine whether one or more movements of the compressible article along one or more orthogonal linear axes and/or in one or more orthogonal planes is a compression on a surface of the compressible article and/or a rotation of the compressible article, collect data relating to the number of compressions and/or rotations, and display to the user on a mobile electronic device the number of compressions and the number of rotations of the compressible article. The computer-executable instructions may be further adapted to modify device firmware to perform such steps. Additionally, the computer-executable instructions may also be adapted to provide instructions and/or compiled and/or processed data to a user interface. The computer-readable medium is generally stored in a hard drive or ROM on a data processing device (e.g., a laptop or tablet computer), or placed into an appropriate medium reader (e.g., CD-ROM reader, DVD reader, flash disk drive, etc.), and therefore be accessible to the data processing device.

Thus, to help implement the present software and/or method of monitoring physical activity, the training module may further comprise one or more memories storing instructions to determine the number of compressions and the number of rotations of the compressible article, display the number of compressions and the number of rotations of the compressible article to the user on the mobile electronic device or a coach or instructor on a portable computer, and/or display commands or indications on the user's mobile electronic device to tap a surface of the training module and/or rotate the training module in a given or predetermined direction.

The signal processing device may be, for example, a mobile device (e.g., smart phone) containing GPS software that can automatically update with the map, relevant index, and relevant map symbols of the physical location of the mobile device. A person driving through a particular geographic location will thus have the map, index, and map symbols automatically update during the travel.

A number of embodiments have been described. Nevertheless, it will be understood that various modifications may be made without departing from the spirit and scope of the invention.

### CONCLUSION/SUMMARY

Thus, embodiments of the present invention relate to a geospatial search portal, systems including the same, and methods of making and using the geospatial search portal. The geospatial search portal generally comprises an electronic information harvester, a tagger, an electronic map having a plurality of electronic locations thereon, and a processor. The electronic information harvester seeks and retrieves relevant scholarly, technical, encyclopedic, factual and/or archival information. The tagger associates a plurality of georeferences and a plurality of metadata to each item of information. The processor is configured to display at least some of the associated information on the electronic map and/or in a textbox when the electronic location(s) on the electronic map, the georeference(s), and/or the metadata is/are electronically selected.

The present geospatial search portal, system and methods can be used to explore verified or verifiable information associated with particular geographic locations and/or features, and is expected to facilitate retention of educational information (e.g., as taught to students, learned by businesspeople or governmental authorities, etc.), and stimulate virtual exploration (or further exploration) of a physical area. The present search portal is scalable, infinitely expandable, and enables limitless virtual field trips to almost anywhere in the world.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A geospatial search portal, comprising:
a) an electronic information harvester that seeks and retrieves scholarly, technical, encyclopedic, factual, and/or archival information;
b) a tagger that associates georeferences and metadata to each of said scholarly, technical, encyclopedic, factual, and/or archival information;
c) logic that analyzes said metadata and organizes said metadata into index terms and/or map symbols;
d) an electronic map having electronic locations thereon;
e) a system that relates or associates each of said georeferences to one or more of said electronic locations identified in said index terms, said metadata, said map symbols, and/or said scholarly, technical, encyclopedic, factual, and/or archival information; and
f) a processor configured to display at least some of said associated scholarly, technical, encyclopedic, factual and/or archival information when one or ones of said electronic locations on said electronic map, one or ones of said georeferences, one or ones of said metadata, one or ones of said index terms, and/or one or ones of said map symbols is/are electronically selected.

2. The search portal of claim 1, wherein said electronic map has a plurality of scales, each of said scales representing a different predetermined distance per unit length on the electronic map.

3. The search portal of claim 2, wherein the electronic map is divided into an array of tiles, said tiles having dimensions fixed to one of said plurality of scales, and each of said electronic locations corresponds to one or more of said tiles.

4. The search portal of claim 1, further comprising a user interface.

5. The search portal of claim 4, further comprising a search box to be displayed on said user interface, adapted to receive search terms for finding said scholarly, technical, encyclopedic, factual, and/or archival information.

6. The search portal of claim 5, wherein said user interface further comprises a function area adapted to display said index terms, each of said index terms being adapted to perform a predetermined function on said map and/or one or ones of said map symbols.

7. The search portal of claim 6, wherein said function area is adapted to display one or ones of said map symbols, each said map symbol being adapted to perform a predetermined function on said index terms.

8. The search portal of claim 1, further comprising a menu adapted to offer a plurality of predetermined functions for changing, displaying or configuring said electronic map, said map symbols, and/or said index terms.

9. The search portal of claim 4, wherein said index terms change when an electronic cursor highlights one or ones of said electronic locations.

10. The search portal of claim 1, wherein said harvester is configured to recognize said scholarly, technical, encyclopedic, factual, and archival information on or in predefined areas of an electronic file.

11. The search portal of claim 1, wherein said logic comprises:
a) an indexer that analyzes each of said metadata and organizes said metadata into said index terms; and
b) a depictor that analyzes each of said metadata and organizes said metadata into said map symbols.

12. A system, comprising:
a) geospatial search portal of claim 1;
b) a server or storage device configured to store said georeferences, said metadata, and links or electronic associations between said georeferences and said corresponding one or ones of said electronic locations on said electronic map; and
c) an electronic display device, configured to display the electronic map.

13. The system of claim 11, further comprising:
one or more information storage units configured to store said georeferences, said metadata, and said links or electronic associations; and
a computer configured to manage read, write and address assignment operations and/or identification operations of said one or more information storage units.

14. A method of creating a search portal, comprising:
a) importing or creating an electronic map having electronic locations thereon;
b) identifying and/or retrieving scholarly, technical, encyclopedic, factual, and/or archival information;
c) tagging each of said scholarly, technical, encyclopedic, factual, and/or archival information with georeferences and metadata;
d) linking said georeferences with said electronic locations on said electronic map;
e) analyzing and organizing each of said metadata into index terms and/or map symbols; and
f) configuring a processor to display at least some of said scholarly, technical, encyclopedic, factual, and/or archival information when a corresponding one or ones of said electronic locations, one or ones of said georeferences, one or ones of said metadata, one or ones of said index terms, and/or one or ones of said map symbols is/are electronically selected.

15. The method of claim 14, wherein each of said electronic locations corresponds to a predetermined tile on the electronic map.

16. The method of claim 14, wherein configuring said processor to display at least some of said scholarly, technical, encyclopedic, factual, and/or archival information comprises creating a user interface configured to display said electronic map, identified and predetermined locations on the electronic map, and relevant information identified in a search.

17. The method of claim 16, wherein said user interface further comprises:
a) a search box adapted to receive search terms for identifying said scholarly, technical, encyclopedic, factual, and/or archival information on said electronic map, and
b) at least one of:
i) a function area adapted to display one or ones of said index terms, each one or ones of said index terms being adapted to perform a predetermined function on said electronic map, one or ones of said map symbols on said electronic map, one or ones of said index terms, and/or said scholarly, technical, encyclopedic, factual, and/or archival information;
ii) a function area adapted to display one or ones of said map symbols, each one or ones of said map symbols being adapted to perform a predetermined function on one or ones of index terms, said electronic map, and/or said scholarly, technical, encyclopedic, factual, and/or archival information; and
iii) a menu adapted to offer a plurality of predetermined functions for changing or configuring said electronic map and/or said index terms

18. A method of finding information relating to an actual geographic location, comprising:
a) searching for information using a geospatial search portal, the geospatial search portal comprising:
i) an electronic map having one or more electronic locations thereon;
ii) scholarly, technical, encyclopedic, factual, and/or archival information with georeferences and metadata, one or ones of said georeferences electronically associated with one or ones of said electronic location(s);
iii) logic that analyzes said metadata and organizes said metadata into index terms and/or map symbols;
iv) a user interface configured to display said electronic map, a predetermined and/or identified electronic location on said electronic map, one or ones of said index terms, and/or said one or ones of said map symbols, and at least some of said scholarly, technical, encyclopedic, factual, and/or archival information relating to said actual geographic location when said identified and/or corresponding electronic location, one or ones of said map symbols, and/or one or ones of said georeferences is/are electronically selected;
b) viewing retrieved information; and
c) optionally exporting or printing at least some of said retrieved information.

19. The method of claim 18, further comprising causing a processor to identify a particular electronic location on said electronic map, and to refine or reconfigure said electronic map and/or said scholarly, technical, encyclopedic, factual, and/or archival information relating to said actual location.

20. The method of claim 18, further comprising filtering said information or selecting a predetermined type of said information using a selectable item from a menu.

21. A non-transitory computer-readable medium containing a set of instructions stored thereon which, when executed by a signal processing device configured to execute computer-readable instructions, is configured to perform the method of claim 18.

22. The method of claim 21, wherein said signal processing device has an actual geographic location, and wherein said signal processing device is configured to select one or ones of said georeferences that are proximate to said actual geographic location of said signal processing device.
